(19) United States
(12) Patent Application Publication
(10) Pub. No.: US 2018/0032992 A1
(43) Pub. Date: Feb. 1, 2018

(54) INFORMATION PROCESSING DEVICE AND NON-TRANSITORY COMPUTER-READABLE MEDIUM

(71) Applicant: FUJI XEROX CO., LTD., Tokyo (JP)

(72) Inventor: Masahiro YASUI, Yokohama-shi (JP)

(73) Assignee: FUJI XEROX CO., LTD., Tokyo (JP)

(21) Appl. No.: 15/484,524

(22) Filed: Apr. 11, 2017

(30) Foreign Application Priority Data
Jul. 29, 2016 (JP) 2016-150476

(51) Int. Cl. G06Q 20/28; H04N 1/00; H04N 1/32

(52) U.S. Cl. CPC G06Q 20/28; H04N 1/32069; H04N 1/00875; H04N 1/00413; H04N 1/32096; H04N 2201/0039; H04N 2201/0093

(57) ABSTRACT

An information processing device includes a receiver and a controller. The receiver receives a process. When the process is executed locally on the information processing device itself, the controller controls a charge device to deduct a fee after completion of a predetermined unit of process constituting the process. When the process is executed on an other device, the controller controls a charge device to deduct a fee before the process is started.

### CROSS-REFERENCE TO RELATED APPLICATIONS

This application is based on and claims priority under 35 USC 119 from Japanese Patent Application No. 2016-150476 filed Jul. 29, 2016.

### BACKGROUND

### Technical Field

The present invention relates to an information processing device and a non-transitory computer-readable medium.

### SUMMARY

According to an aspect of the invention, there is provided an information processing device including a receiver and a controller. The receiver receives a process. When the process is executed locally on the information processing device itself, the controller controls a charge device to deduct a fee after completion of a predetermined unit of process constituting the process. When the process is executed on an other device, the controller controls a charge device to deduct a fee before the process is started.

### BRIEF DESCRIPTION OF THE DRAWINGS

An exemplary embodiment of the present invention will be described in detail based on the following figures, wherein:

FIG. 1 is a diagram illustrating an exemplary configuration of an information processing system according to an exemplary embodiment of the present invention;

FIG. 2 is a block diagram illustrating an exemplary configuration of a first information processing device;

FIG. 3 is a block diagram illustrating an exemplary configuration of a second information processing device;

FIG. 4 is a timing chart illustrating an example of operations of an information processing system;

FIG. 5 is a flowchart illustrating an example of operations of a second information processing device; and

FIG. 6 is a flowchart illustrating an example of operations of a first information processing device.

### DETAILED DESCRIPTION

Hereinafter, an exemplary embodiment of the present invention will be described with reference to the drawings. Note that in the drawings, structural elements that have substantially the same function are denoted with the same signs, and duplicate description thereof will be reduced or omitted.

(Information Processing System)

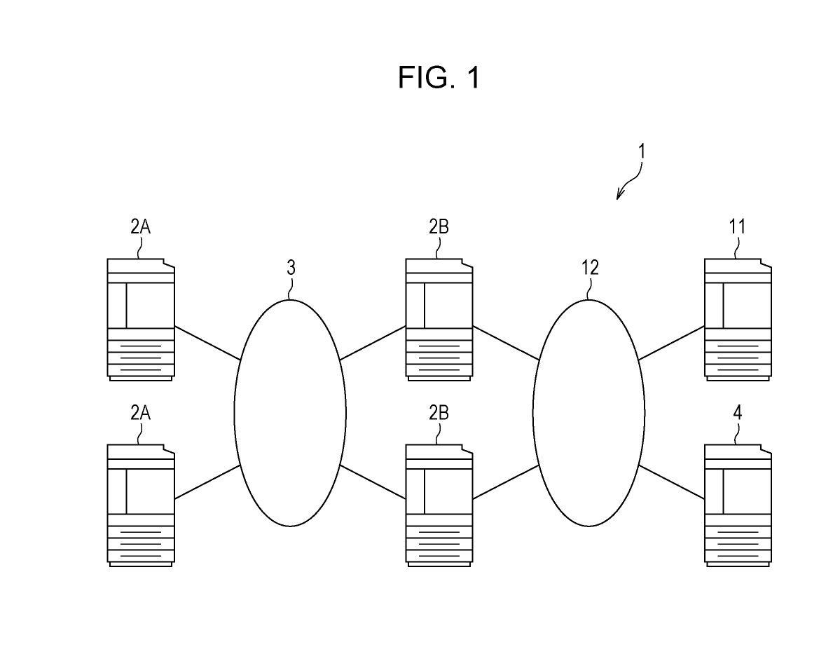

FIG. 1 is a diagram illustrating an exemplary configuration of an information processing system according to an exemplary embodiment of the present invention. The information processing system 1 is provided with a first information processing device 2A, and a second information processing device 2B connected to the first information processing device 2A via a private network 3 and also connected to an external device 11 via a public network 12.

The second information processing device 2B has a function that the first information processing device 2A does not have. Note that the first and the second information processing devices 2A and 2B may be referred to collectively as the “information processing devices 2” in some cases. Also, although the drawing illustrates two of each of the first and the second information processing devices 2A and 2B, the number of each information processing device may be one, or three or more.

The first information processing device 2A is, for example, a multi-function device that does not include a facsimile (hereinafter also called “fax”) function, but does include multiple functions such as a scan function, a print function, a copy function, and a communication function. Note that the first information processing device 2A may also be a device such as a personal computer (PC) or a smartphone not provided with a fax modem.

Even if the first information processing device 2A does not include a fax function, the first information processing device 2A is still able to execute a fax job by transmitting a multicast command to the private network 3 to thereby determine whether or not a second information processing device 2B including a fax function exists on the same private network 3, and if so, the first information processing device 2A ascertains how many second information processing devices 2B exist, and also obtains information such as an IP address specifying each second information processing device 2B that exists. The first information processing device 2A stores this information locally in internal memory, and when conducting fax communication, requests a second information processing device 2B to transmit a fax on the basis of the information.

The second information processing device 2B is, for example, a multi-function device that includes a fax function, and also includes multiple functions such as a scan function, a print function, a copy function, and a communication function. In the case of receiving a request to transmit a fax from the first information processing device 2A, the second information processing device 2B faxes scan data transmitted from the first information processing device 2A to an external device 11 specified as the recipient.

The private network 3 is a communication network on which high-speed communication is available for free or at very low cost, and is an internal network such as a local area network (LAN) or an intranet, for example. The private network 3 may be wired or wireless. The first and second information processing devices 2A and 2B are installed in a location such as an office or school facility, for example.

The external device 11 is a device such as a facsimile (fax) machine, a personal computer (PC) provided with a fax function, or a multi-function device provided with multiple functions including a fax function, for example.

The public network 12 is a paid communication network operated by a communication company, and is an external network such as the public switched telephone network (PSTN) or an Integrated Services Digital Network (ISDN), for example.

(First Information Processing Device)

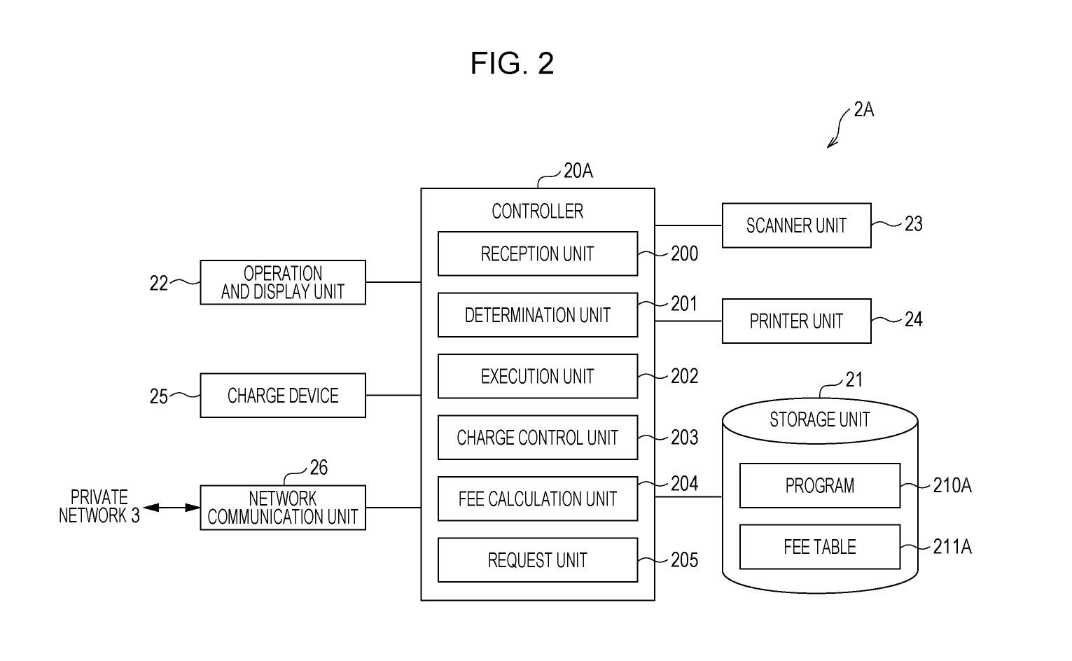

FIG. 2 is a block diagram illustrating an exemplary configuration of the first information processing device 2A. The first information processing device 2A includes a controller 20A. Connected to the controller 20A are a storage unit 21 which is an example of memory, an operation and display unit 22, a scanner unit 23, a printer unit 24, a charge device 25, and a network communication unit 26. The charge device 25 may also be configured separately from the first information processing device.

The storage unit 21 is made up of read-only memory (ROM), random access memory (RAM), a hard disk, or the like, and stores information such as a program 210A by which a central processing unit (CPU) executes various functions, and a fee table 211A.

The operation and display unit 22 includes a touch panel, for example, and accepts input such as instructions from an operator, while also presenting a display to the operator. The scanner unit 23 is provided with a scanner and an automatic feeder that automatically feeds a document to a scanning position, for example, and reads image data (scan data) from a document. The printer unit 24 includes an image retainer made up of a photoreceptor, for example, and forms an image onto a recording medium such as a paper sheet for output.

The charge device 25 is a device that charges a monetary fee, and is provided with a slot for inserting cash such as coins or paper currency, a return button for returning inserted cash to a return slot, a lock unit that locks the operation of return button, and a cash processing unit that processes inserted cash. The lock unit locks the operation of the return button on the basis of a lock signal from the controller 20A, and releases the lock on the operation of the return button on the basis of a lock release signal from the controller 20A. The cash processing unit conducts a process (charge process) of counting the total amount of inserted cash (inserted amount) and deducting a fee reported by the controller 20A from the inserted amount. Additionally, if there is change left over, the cash processing unit returns the change to the return slot.

The network communication unit 26 controls the transmission and reception of email and conducts network-related control in accordance with a communication protocol such as TCP/IP, and thereby transmits and receives data via the private network 3.

The controller 20A is made up of components such as a CPU and an interface. The CPU, by operating in accordance with the program 210A, functions as a reception unit 200, a determination unit 201, an execution unit 202, a charge control unit 203, a fee calculation unit 204, a request unit 205, and the like.

Additionally, in the case of locally executing a first process constituting part of a received process, and requesting another device to execute a remaining second process, the controller 20A controls the operation and display unit 22 to display an amount totaling a first fee for the first process and a second fee for the second process as the fee for the process. Consequently, the user is able to know the fee for the entire process.

The reception unit 200 receives a job selected from among multiple jobs included on a menu screen. In addition, the reception unit 200 receives a recipient specified on a fax job settings screen, and an instruction to start the job. The jobs included on the menu screen include jobs such as a scan job, a print job, a copy job, and a fax job. These jobs are examples of a process. A fax job includes a scan job and a fax transmission job. A scan job is an example of the first process constituting part of a received process, while a fax transmission job is an example of the remaining second process.

The determination unit 201 determines whether a job received by the reception unit 200 is executable on the local, first information processing device 2A or on an other, second information processing device 2B.

The execution unit 202 executes a job received by the reception unit 200. If the job received by the reception unit 200 is a fax job, for example, since the local device does not include a fax function, the execution unit 202 executes the scan job which is one part of the fax job and, via the request unit 205, requests the second information processing device 2B to execute the fax transmission job.

In the case of executing the entire job locally, the charge control unit 203 controls the charge device 25 to deduct a corresponding fee after the completion of a predetermined unit of process constituting the job, such as the process for one sheet, for example. On the other hand, in the case of executing part of the job on another device, the charge control unit 203 controls the charge device 25 to deduct the fee before the process is started on the other device. For example, if the job is a fax job, when an instruction to start a scan is given, the charge control unit 203 transmits a lock signal to the charge device 25, thereby causing the return button to be locked, and after a fee reported from the second information processing device 2B requested to execute fax transmission is reported to the charge device 25 to cause the charge device 25 to conduct a charge process, the charge control unit 203 transmits a lock release signal to the charge device 25 causing the lock on the return button to be released.

The fee calculation unit 204 references the fee table 211A to calculate a fee corresponding to a job. If the job is a print job, for example, a fee corresponding to print color (that is, color or monochrome printing) and the number of pages to print is registered in the fee table 211A.

The request unit 205 transmits scan data and recipient information to the second information processing device 2B including a fax function selected as a relay device, and thereby requests fax transmission.

(Second Information Processing Device)

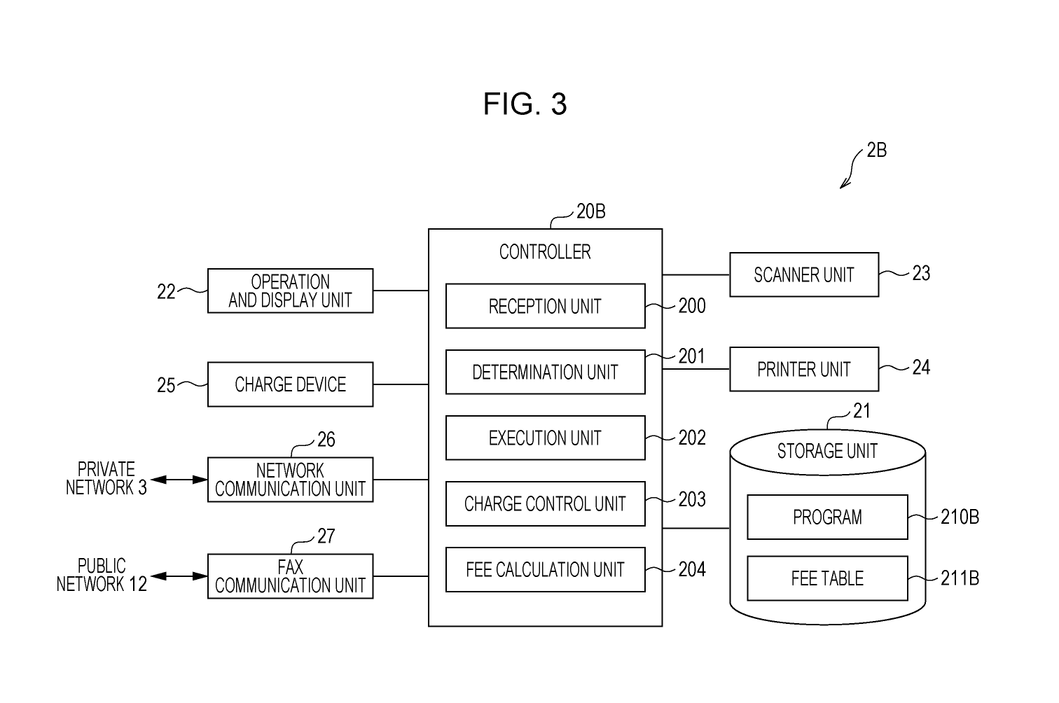

FIG. 3 is a block diagram illustrating an exemplary configuration of the second information processing device 2B. The second information processing device 2B corresponds to the first information processing device 2A with the addition of a fax function, and otherwise is configured similarly to the first information processing device 2A. Hereinafter, the points that differ from the first information processing device 2A will be described for the most part.

Namely, the second information processing device 2B includes a controller 20B. Connected to the controller 20B are a storage unit 21 which is an example of memory, an operation and display unit 22, a scanner unit 23, a printer unit 24, a network communication unit 26, and a fax communication unit 27.

The storage unit 21 is made up of ROM, RAM, a hard disk, or the like, and stores information such as a program 210B by which a CPU executes various functions, and a fee table 211B.

The controller 20B is made up of components such as a CPU and an interface. The CPU, by operating in accordance with the program 210B, functions as a reception unit 200, a determination unit 201, an execution unit 202, a charge control unit 203, a fee calculation unit 204, and the like, but does not function as the request unit 205 included in the first information processing device 2A.

The fax communication unit 27 includes the functionality of a modem that modulates and demodulates image data according to a facsimile protocol such as G3 or G4, and the functionality of a network control unit (NCU) that controls connections with the public network 12, and conducts fax communication via the public network 12.

Similarly to the first information processing device 2A, the reception unit 200 receives a job selected from among multiple jobs included on a menu screen, and receives a recipient specified on a fax job settings screen, as well as an instruction to start a job.

The determination unit 201 determines whether a job received by the reception unit 200 is executable on the local, second information processing device 2B or on an other, first information processing device 2A.

The execution unit 202 executes a job received by the reception unit 200. If the job received by the reception unit 200 is a fax job, since the local device includes a fax function, the execution unit 202 executes the scan job and the fax transmission job locally.

In the case of executing the entire job locally, the charge control unit 203 controls the charge device 25 to deduct a corresponding fee after the completion of a predetermined unit of process constituting the job, such as the process for one sheet, for example. For example, if the job is a fax job, when a scan is started, the charge control unit 203 transmits a lock signal to the charge device 25, reports a fee to the charge device 25 and causes the charge device 25 to conduct a charge process every time a single sheet is faxed, and when the entire fax transmission is finished, the charge control unit 203 transmits a lock release signal to the charge device 25.

The fee calculation unit 204 references the fee table 211B to calculate a fee corresponding to a job. If the job is a print job, for example, a fee corresponding to print color (that is, color or monochrome printing) and the number of pages to print is registered in the fee table 211B. Also, if the job is a fax job or a fax transmission job, for example, a fee corresponding to the communication distance and the amount of data to communicate is registered in the fee table 211B.

(Operations of Information Processing System)

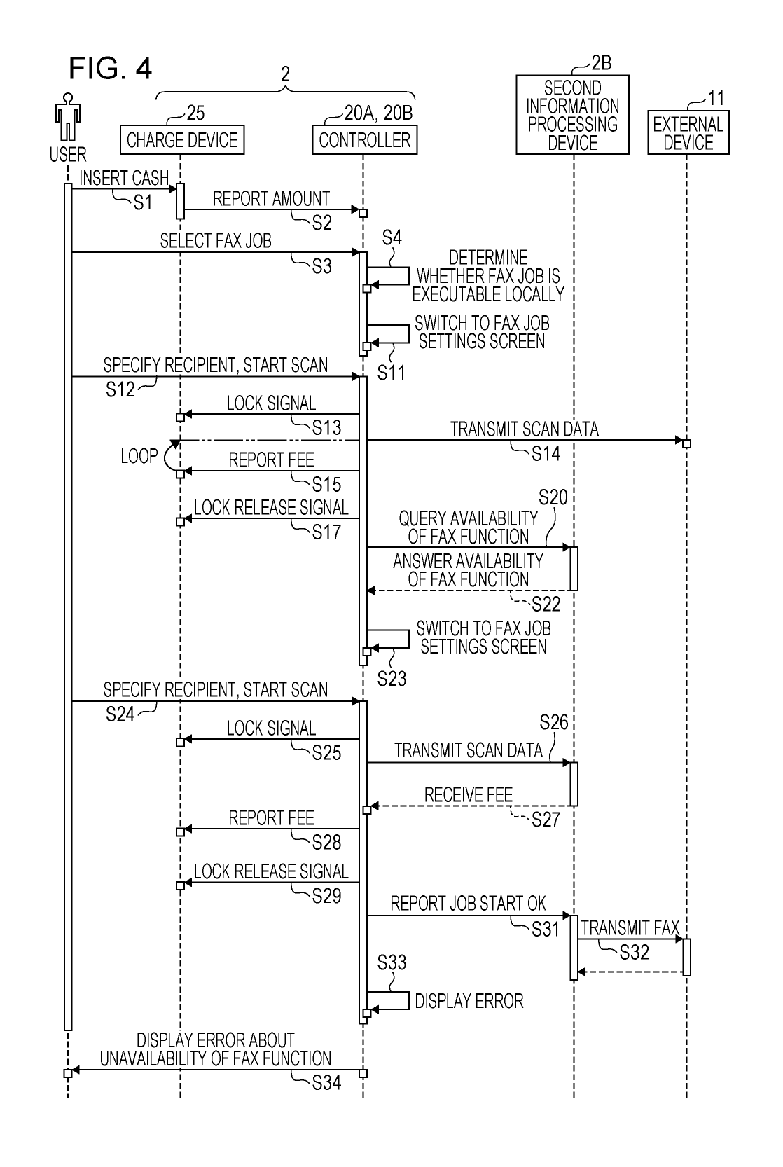

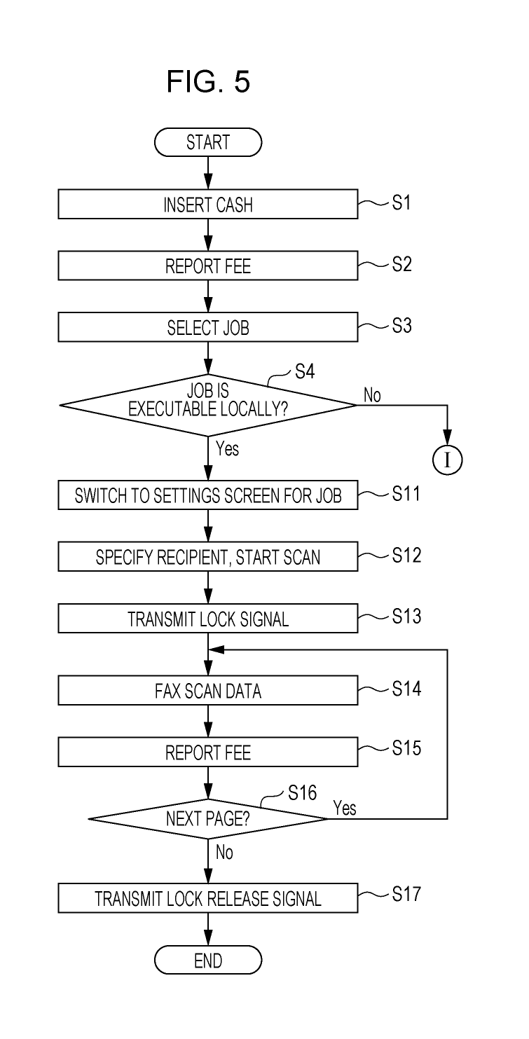

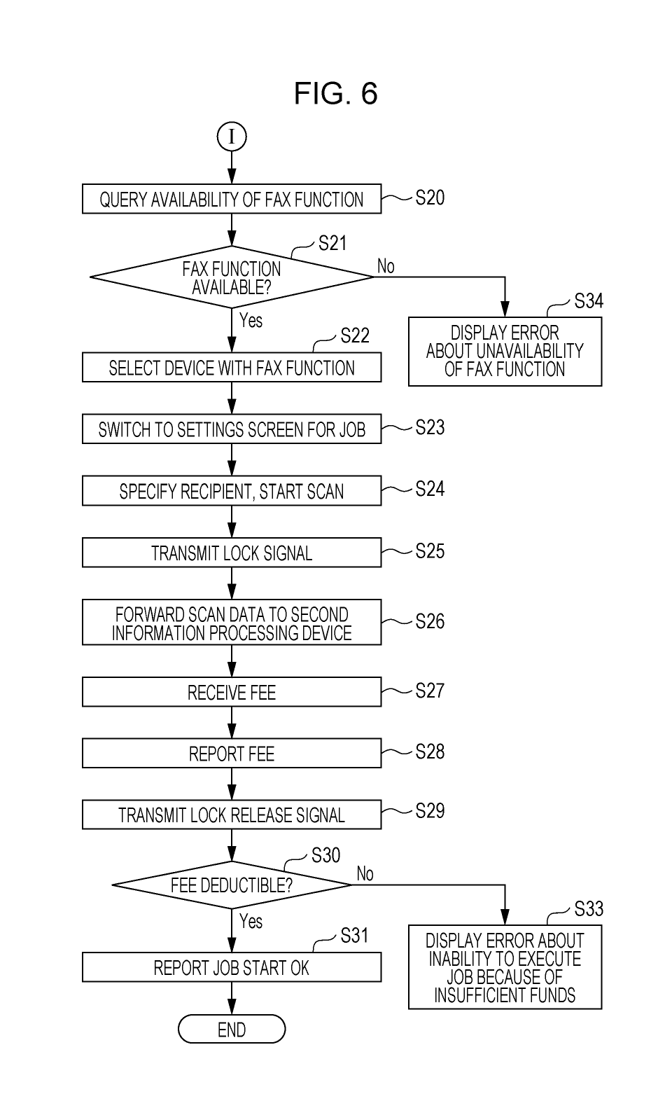

Next, an example of the operations of the information processing system 1 will be described with reference to FIGS. 4 to 6. FIG. 4 is a timing chart illustrating an example of the operations of the information processing system 1, while FIG. 5 is a flowchart illustrating an example of the operations of the second information processing device 2B. FIG. 6 is a flowchart illustrating an example of the operations of the first information processing device 2A.

(1) Case of User Operating the Second Information Processing Device 2B

A case of the user operating the second information processing device 2B will be described with reference to FIGS. 4 and 5.

If the user inserts cash into the charge device 25 of the second information processing device 2B (S1), the cash processing unit of the charge device 25 reports the amount of inserted cash (inserted amount) to the controller 20B (S2).

The user causes the operation and display unit 22 of the second information processing device 2B to display a menu screen, and selects a fax job, for example, from among the multiple jobs included on the menu screen (S3). The reception unit 200 receives the fax job, and the determination unit 201 determines whether or not the fax job received by the reception unit 200 is executable on the local second information processing device 2B (S4).

Since the second information processing device 2B includes a fax function, the determination unit 201 determines that the fax job is executable on the local device (S4: Yes), and switches the screen on the operation and display unit 22 from the menu screen to a fax job settings screen (S11).

The user places multiple document pages in the scanner unit 23, and on the fax job settings screen displayed on the operation and display unit 22, specifies a recipient and presses a scan button to start scanning (S12). The reception unit 200 receives the recipient and the instruction to start scanning. The execution unit 202 controls the scanner unit 23 to execute scanning, and successively generates scan data. The scan data is stored temporarily in the storage unit 21.

When a scan is started, the charge control unit 203 transmits a lock signal to the charge device 25 (S13). The lock unit of the charge device 25 locks the return button on the basis of the lock signal from the charge control unit 203. Consequently, the user becomes unable to withdraw inserted cash.

The execution unit 202 faxes scan data to the external device 11 specified as the recipient (S14). The fee calculation unit 204 references the fee table 211B on the basis of the scan data and the recipient, calculates the fee to fax one page, and reports the calculated fee to the charge device 25 (S15). The cash processing unit of the charge device 25 deducts the reported fee from the inserted amount, and retains the remaining amount. If a next page exists (S16: Yes), the fax transmission of scan data (S14) and the reporting of the fee (S15) are repeated for the next page.

If a next page does not exist (S16: No), the charge control unit 203 transmits a lock release signal to the charge device 25. The lock unit of the charge device 25 releases the lock on the return button, on the basis of the lock release signal from the charge control unit 203. If any remaining money exists after deducting all fees from the inserted amount, the charge device 25 returns the remaining money to the return slot as change.

(2) Case of User Operating the First Information Processing Device 2A

A case of the user operating the first information processing device 2A will be described with reference to FIGS. 4 to 6.

If the user inserts cash into the charge device 25 of the first information processing device 2A (S1), the charge device 25 reports the amount of inserted cash (inserted amount) to the controller 20A (S2).

The user causes the operation and display unit 22 of the first information processing device 2A to display a menu screen, and selects a fax job, for example, from among the multiple jobs included on the menu screen (S3). The reception unit 200 receives the fax job, and the determination unit 201 determines whether or not the fax job received by the reception unit 200 is executable on the local first information processing device 2A (S4).

Since the first information processing device 2A does not include a fax function, the determination unit 201 determines that the fax job is not executable on the local device (S4: No). The request unit 205 queries whether or not any first information processing device 2A or second information processing device 2B connected to the private network 3 includes a fax function (S20).

If there is not response indicating the availability of a fax function (S21: No), the request unit 205 presents an error display on the operation and display unit 22 indicating that the fax function is unavailable (S34).

If there is a response indicating the availability of a fax function S21: Yes), the request unit 205 selects one of the second information processing devices 2B that responded to indicate an available fax function as a relay device (S22).

The determination unit 201 switches the screen of the operation and display unit 22 from the menu screen to a fax job settings screen (S23).

The user places multiple document pages in the scanner unit 23, and on the fax job settings screen displayed on the operation and display unit 22, specifies a recipient and presses a scan button to start scanning (S24). The reception unit 200 receives the recipient and the instruction to start scanning.

When a scan is started, the charge control unit 203 transmits a lock signal to the charge device 25 (S25). The charge device 25 locks the return button on the basis of the lock signal.

The request unit 205 transmits scan data and recipient information to the second information processing device 2B selected as a relay device, and thereby requests fax transmission (S26). The fee calculation unit 204 of the second information processing device 2B references the fee table 211B on the basis of the scan data and the recipient to calculate a fee, and reports the calculated fee to the first information processing device 2A.

The controller 20A of the first information processing device 2A receives the fee reported from the second information processing device 2B (S27). The controller 20A reports the received fee to the charge device 25 (S28).

The charge control unit 203 transmits a lock release signal to the charge device 25 (S29). The charge device 25 releases the lock on the return button on the basis of the lock release signal.

The charge device 25 determines whether or not all fees are deductible from the inserted cash (S30). If deductible (S30: Yes) the fees are deducted.

An OK to start the job is reported to the second information processing device 2B (S31). The execution unit 202 of the second information processing device 2B faxes scan data to the external device 11 specified as the recipient.

If the fees are not deductible (S30: No), an indication that execution of the job will not continue because of insufficient funds is displayed on the operation and display unit 22 (S33).

The above thus describes an exemplary embodiment of the present invention, but an exemplary embodiment of the present invention is not limited to the foregoing exemplary embodiment, and various modifications are possible within a scope that does not depart from the gist of the present invention. For example, the charge device 25 may also be provided with a card processing unit that processes a card such as a prepaid card or a cash card, and may also be provided with a processing unit to process electronic money or the like. In this case, if the inserted card is a cash card, the card processing unit reads account information from the cash card, and deducts the fee from a bank account via a network communication unit connected to the Internet or the like. If the inserted card is a prepaid card, the fee is deducted from the remaining balance on the prepaid card.

The foregoing exemplary embodiment describes a case of executing a scan job as the first process and a fax transmission job as the second process, but a job may also be executed in which a scan job is executed as the first process, and a translation job of translating the scan data is executed as the second process. Also, a job may be executed in which a scan job is executed as the first process, and a job of translating the scan data into document data corresponding the language of the country where the recipient external device is installed, and faxing the translated document data to the external device, may be executed as the second process.

When a received process is executed by another device, the controller 20A of the first information processing device 2A may also acquire the fee on the other device before the process is started, display the acquired fee on the operation and display unit 22, and prompt the user for permission to execute the process. In this case, if the user does not give permission to execute the process, the process is aborted. For example, the process may be aborted if the fee is higher than expected.

The respective functional units of the controllers 20A and 20B may also be realized in part or in full by a hardware circuit such as a field-programmable gate array (FPGA) or an application-specific integrated circuit (ASIC).

Furthermore, it is also possible to omit or modify some of the structural elements of the foregoing exemplary embodiment, within a scope that does not depart from the gist of the present invention. In addition, in the flows of the foregoing exemplary embodiment, steps may be added, removed, modified, rearranged, or the like, within a scope that does not depart from the gist of the present invention. Also, a program used by the foregoing exemplary embodiment may be provided by being recorded on a computer-readable recording medium such as a CD-ROM.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device, comprising:
a receiver that receives a process; and
a controller that, when the process is executed locally on the information processing device itself, controls a charge device to deduct a fee after completion of a predetermined unit of process constituting the process, and when the process is executed on an other device, controls a charge device to deduct a fee before the process is started.

2. An information processing device, comprising:
a receiver that receives a process;
a determination unit that determines whether the process is executable locally on the information processing device itself, or on an other device; and
a controller that, on a basis of a determination result from the determination unit, when the process is executed locally on the information processing device itself, controls a charge device to deduct a fee after completion of a predetermined unit of process constituting the process, and when the process is executed on the other device, controls a charge device to deduct a fee before the process is started.

3. The information processing device according to claim 1, wherein
in a case of executing a first process constituting part of the process locally on the information processing device itself, and requesting an other device to execute a remaining second process, the controller controls the charge device to deduct the fee to be deducted after completion of the unit of process before the second process is started.

4. The information processing device according to claim 2, wherein
in a case of executing a first process constituting part of the process locally on the information processing device itself, and requesting an other device to execute a remaining second process, the controller controls the charge device to deduct the fee to be deducted after completion of the unit of process before the second process is started.

5. The information processing device according to claim 3, further comprising:
a display that display a fee with respect to the process, wherein
the controller controls the display to display, as the fee for the process, a monetary amount obtained by totaling a first fee with respect to the first process, and a second fee with respect to the second process.

6. The information processing device according to claim 4, further comprising:
a display that display a fee with respect to the process, wherein
the controller controls the display to display, as the fee for the process, a monetary amount obtained by totaling a first fee with respect to the first process, and a second fee with respect to the second process.

7. The information processing device according to claim 1, further comprising:
a display that display a fee with respect to the process, wherein
when the process is executed by the other device, the controller acquires a fee on the other device before the process is started, displays the acquired fee on the display, and asks for permission to execute the process.

8. The information processing device according to claim 2, further comprising:
a display that display a fee with respect to the process, wherein
when the process is executed by the other device, the controller acquires a fee on the other device before the process is started, displays the acquired fee on the display, and asks for permission to execute the process.

9. A non-transitory computer-readable medium storing a program causing a computer to execute a process for processing information, the process comprising:
receiving a process; and
when the process is executed locally on the information processing device itself, controlling a charge device to deduct a fee after completion of a predetermined unit of process constituting the process, and when the process is executed on another device, controlling a charge device to deduct a fee before the process is started.
